(19) United States
(12) Patent Application Publication
(10) Pub. No.: US 2001/0010179 A1
(43) Pub. Date: Aug. 2, 2001

(54) Steering wheel cover

(76) Inventor: Wun-Shian Ku, Taichung (TW)

Correspondence Address: John S. Egbert, Harrison & Egbert, 7th Floor, 412 Main St., Houston, TX, 77002, US

(21) Appl. No.: 09/828,611

(22) Filed: Apr. 9, 2001

Related U.S. Application Data
(63) Continuation-in-part of application No. 09/495,365, filed on Feb. 1, 2000.

(51) Int. Cl. B62D 1/06

(52) U.S. Cl. 74/558

(57) ABSTRACT

A steering wheel cover includes an outer layer and an inner layer. The outer layer is made of a transparent or translucent material. The inner layer is printed with patterns of various colors and is attached to the inner side of the outer layer to provide the steering wheel cover with a decorative effect. The steering wheel cover is attached to the steering wheel such that the inner layer is in contact with the steering wheel. The outer layer is formed of a polymeric material. The inner and outer layers are removably attached to the steering wheel.

### CROSS REFERENCE TO RELATED APPLICATIONS

The present application is a continuation-in-part of U.S. patent application Ser. No. 09/495,365, filed on Feb. 1, 2000, and entitled “STEERING WHEEL COVER”, presently pending.

### BACKGROUND OF THE INVENTION

1. Field of the Invention

The present invention relates generally to a steering wheel, and more particularly to a cover of the steering wheel.

2. Description of Related Art

There are a variety of conventional steering wheel covers, which are generally defective in design in that they are monotonous and that they are not durable. As a result, the conventional steering wheel covers fail to catch the fancy of the consumer. In addition, the conventional steering wheel covers are too complicated in construction and are therefore not cost-effective.

### BRIEF SUMMARY OF THE INVENTION

It is therefore the primary objective of the present invention to provide a steering wheel cover which is versatile in design.

It is another objective of the present invention to provide a steering wheel cover which is cost-effective.

In keeping with the principle of the present invention, the foregoing objectives of the present invention are attained by a steering wheel cover comprising an outer layer and an inner layer. The outer layer is made of a transparent or translucent polymeric material. The inner layer is printed with patterns of various colors and is attached to the outer layer to provide the steering wheel cover with a decorative effect. The outer layer and the inner layer are removably attached to an exterior surface of the steering wheel such that the inner layer is in contact with the exterior surface of the steering wheel. The colored pattern of the inner layer is visible through the outer layer.

The foregoing objectives, features, functions, and advantages of the present invention will be more readily understood upon a thoughtful deliberation of the following detailed description of the embodiments of the present invention with reference to the accompanying drawings.

### BRIEF DESCRIPTION OF THE SEVERAL VIEWS OF THE DRAWINGS

FIG. 1 shows a partial perspective view of the present invention.

FIG. 2 shows a cross sectional view of the present invention.

FIG. 3 shows a partial perspective view of a second preferred embodiment of the present invention.

FIG. 4 shows a partial sectional view of the second preferred embodiment of the present invention.

FIG. 5 shows a cross sectional view of the second preferred embodiment of the present invention.

FIG. 6 shows a partial sectional view of a third preferred embodiment of the present invention.

### DETAILED DESCRIPTION OF THE INVENTION

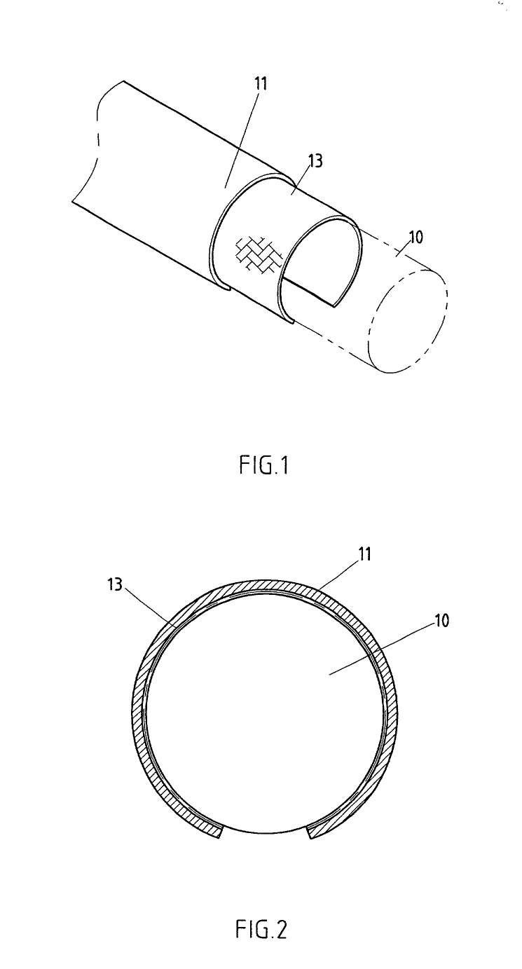

As shown in FIGS. 1 and 2, a steering wheel cover embodied in the present invention comprises an outer layer 11 and an inner layer 13.

The outer layer 11 is transparent or translucent and is made of an elastic polymeric material. The inner layer 13 is printed with patterns of various colors. The inner layer 13 is attached to the outer layer 11 such that the patterns of the inner layer 13 are readily visible through the outer layer 11. The steering wheel cover of the present invention is removably attached to a steering wheel 10 such that the inner layer 13 is in contact with an exterior surface of the steering wheel 10.

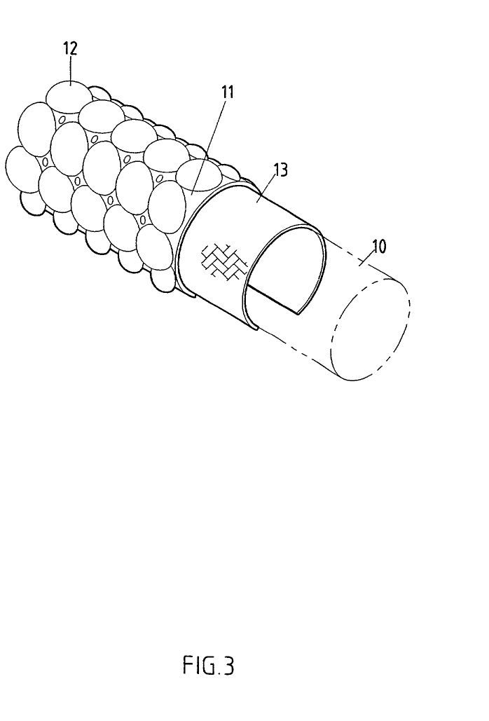

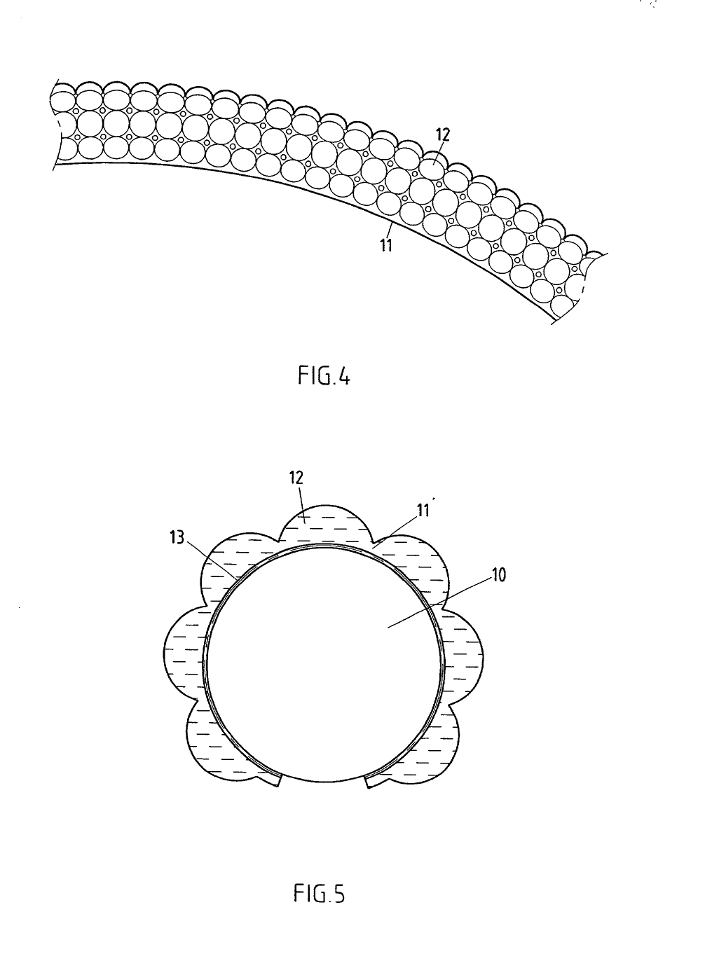

As shown in FIGS. 3, 4, and 5, the outer layer 11 of the steering wheel cover of the present invention is provided in the outer surface thereof with a number of knobs 12 which are either transparent or translucent. The knobs 12 are intended to give an added decorative effect to the steering wheel cover of the present invention and to provide friction between the steering wheel cover of the present invention and the hands holding the steering wheel 10.

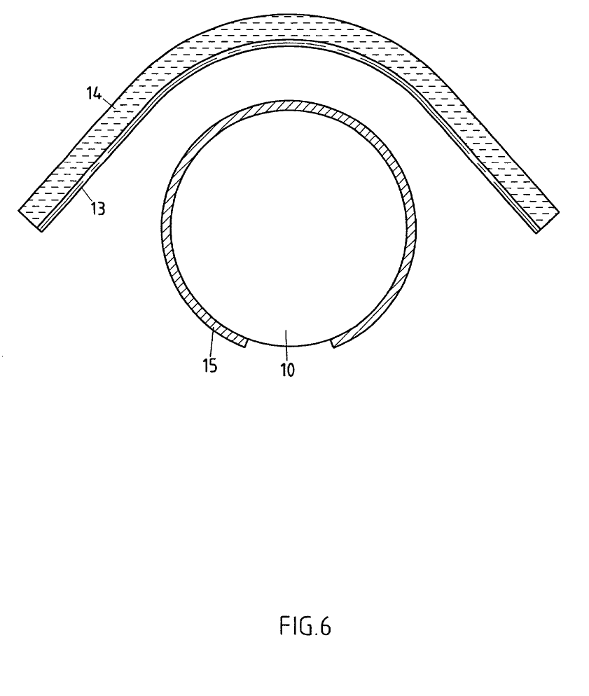

As shown in FIG. 6, a steering wheel cover embodied in the present invention comprises a outer body 14 and an inner layer 13. The outer body 14 is transparent or translucent. The inner layer 13 is patterned. The steering wheel cover is attached to the steering wheel 10 such that the outer body 14 is fastened with a blank cover 15 of the steering wheel 10 by sewing.

The steering wheel covers of the present invention are simple in construction and are therefore cost-effective. The present invention can be made in quantity at low cost. Moreover, the steering wheel cover of the present invention is versatile in design.

The embodiments of the present invention described above are to be regarded in all respects as being merely illustrative and not restrictive. Accordingly, the present invention maybe embodied in other specific forms without deviating from the spirit thereof. The present invention is therefore to be limited only by the scope of the following appended claims.

I claim:

1. A cover apparatus comprising:
a steering wheel;
an outer layer of an elastic polymeric material, said outer layer being transparent or translucent; and
an inner layer printed with colored patterns, said inner layer attached to an inner surface of said outer layer, said outer layer and said inner layer being removably attached to an exterior surface of said steering wheel such that said inner layer is in contact with the exterior surface of said steering wheel, said colored pattern being visible through said outer layer.

2. The cover apparatus as defined in claim 1, wherein said outer layer has a plurality of knobs formed on an outer surface thereof, said knobs being transparent or translucent.

3. The cover apparatus as defined in claim 1, said steering wheel having a blank cover affixed thereto, said outer layer and said inner layer being attached to said blank cover of said steering wheel.
